(19) United States
(12) Patent Application Publication
(10) Pub. No.: US 2018/0293461 A1
(43) Pub. Date: Oct. 11, 2018

(54) METHOD AND DEVICE FOR DETECTING COPIES IN A STREAM OF VISUAL DATA

(71) Applicant: COMMISSARIAT A L'ENERGIE ATOMIQUE ET AUX ENERGIES ALTERNATIVES, PARIS (FR)

(72) Inventors: Hervé LE BORGNE, PARIS (FR); Etienne GADESKI, ORSAY (FR); Adrian POPESCU, MONTROUGE (FR)

(21) Appl. No.: 15/767,629

(22) PCT Filed: Dec. 7, 2015
(86) PCT No.: PCT/EP2015/078822

§ 371 Date: Apr. 11, 2018

(30) Foreign Application Priority Data
Oct. 12, 2015 (FR) 1559680

(51) Int. Cl. G06K 9/62; G06T 1/00; G06T 3/40

(52) U.S. Cl. CPC G06K 9/6212; G06T 1/0028; G06T 2201/0201; G06K 9/6215; G06T 3/40

(57) ABSTRACT

A method and a device for detecting copies or near-copies of images, comprises receiving an initial image, converting the initial image to grayscale, resizing the grayed image to a reduced image having a plurality of rows and an even number of columns, computing an overall signature for the reduced image, and determining whether the initial image is a copy or near-copy of an image according to the result of a comparison between the overall signature of the reduced image and reference image signatures. The step of computing the overall signature comprises the steps of computing a row signature for each row of the reduced image, the computation being based on a comparison of values obtained statistically across subsets of symmetrical pixels in each row, and concatenating the row signatures in order to obtain an overall signature.

### FIELD OF THE INVENTION

The invention relates to the field of transmission and exchange of multimedia documents, for example an image or a video. More specifically, the invention relates to the detection of near-copies of visual content.

### PRIOR ART

The rise of the social web has led to a massive increase in the propagation of visual content—images, video—across websites or across the profiles of users of online social networks (OSNs). The released and relayed content may be identical, in which case reference is made to copies of content, or even contain minor changes, in which case reference is made to near-copies of content. Throughout the rest of the description, the expressions “content copy”, “image copy”, “copy detection” and other variants using the term “copy” will be interpreted as encompassing the terms “copy” and/or “near-copy”.

It is generally accepted that the near-copy of an image is a reference image that has undergone one or a combination of transformations. Reference images may belong to a fixed base of images or else have been collected beforehand via a stream of visual data.

The following transformations are examples of those that are the most likely to be encountered on the Internet, from among current images published on the main social media outlets, namely blogs, social networks, forums, online newspapers, etc.:

compression, to JPEG for example;

a change in encoding, such as PNG conversion for example;

flipping, through left-right inversion for example;

a change in ratio (scaling);

cropping, with e.g. the edges of the image being deleted, and not necessarily centered;

a colorimetric conversion, to grayscale or sepia for example;

a small rotation, less than 20° for example;

embedding text (title, signature, etc.) or images (e.g. a logo).

The detection of copies of an item of reference visual content has multiple practical benefits in the field of social media analysis, whether for blogs, social networks, forums or else online newspapers. This problem is at the core of various applications, such as searching for illegal copies of protected content, measuring the popularity of content, monitoring social media or else locating programming within a video, to name but a few advantageous applications.

Regardless of its use, copy detection is an operation consisting of identifying an image by its content, a technique known as “content-based retrieval”. An important feature to be taken into account in the field of social networks is that content is a data stream that must be processed continuously, and as such copy detection (image or keyframe extracted from a video) originating from a stream of visual data is generally concentrated on the time taken for searching online for an image in a reference base and on the robustness to the various transformations that an image may undergo. Thus, the known approaches for detecting copies or near-copies rely on a method wherein the compact visual signatures are constructed by aggregating local features of an image in order to speed up the search process. In the case of a stream of digital visual data wherein the processing of a copy detection request includes the computation of a signature for the image to be analyzed and the search for a near-copy in the reference images, it is necessary for the total processing time to be compatible with the bit rate of the data stream to be processed.

However, the cost of computing and aggregating local features is non-negligible and the indexing time (signature computation) must be sufficiently short from the moment that the processing of image streams is envisaged. The time taken for computing visual signatures must be compatible with the frequency of reception of new data. More specifically, the indexing and search operations must be executed at a rate that is higher than that of the collection of new data from the incoming stream. For example, if a system digests half a million visual multimedia articles per day, the comparison thereof with recent content, assumed to include 10 to 100 million documents, must be carried out in less than (24×3600)/500 000=172.8 milliseconds, i.e. of the order of six images per second. Such a demanding processing rate makes the use of signatures based on the transformation and compression of local features difficult to employ if computing resources are limited. Thus, the time taken to process a request must also be balanced against the computing resources (memory, processor) required to provide the service.

FIG. 1 shows a standard processing chain for copy detection. The general principle consists of searching through a reference base for an image by its content and deciding whether the image is a copy or near-copy of a reference image. Thus, the device for processing a request comprises, in a first offline processing chain (102), a module for extracting visual features (104-1) which consists of setting up a vector representation of a given image (reference documents), which representation may comprise one or more vectors, and an indexing module (106) for indexing the descriptors arising from the extraction of the features, and thus forming an indexed reference base that may be efficiently searched. Optionally, the indexing may comprise labels in the event that multiple reference images are themselves near-copies.

The device additionally comprises a second, online, processing chain (108) for processing a request that comprises a module for extracting visual features (104-2) in order to set up a vector description of a request image, coupled with a comparison module (110) that uses the vector description of the request image and interrogates the reference base in order to find similar images, and which is coupled with a decision module (112) in order to determine whether or not the request image is a copy of a reference image.

Most of the known work in the field of multimedia is based on the extraction of local descriptors in order to represent images. In each reference image, a set of points of interest is selected as corresponding to points in the image that are visually notable and likely to be found even after the image has been altered. A local descriptor is subsequently computed in spatial vicinity to each point of interest.

Such an approach is shown in the patent application WO 2009/095616 by Gengembre Nicolas et al. entitled “Method of identifying a multimedia document in a reference base, corresponding computer program and identification device”, or else in the article by Joly, A., Buisson, O. and Frelicot, C. entitled “Content-Based Copy Retrieval Using Distortion-Based Probabilistic Similarity Search”, Multimedia, IEEE Transactions on vol. 9, no. 2, pp. 293, 306, February 2007.

However, this method is quite expensive in terms of computing time, both for extracting the local descriptors and, above all, finding the reference documents when the reference base becomes large.

Consequently, the methods using local descriptors exhibit good performance and efficient indexing schemes have been proposed in order to make use of them for quick image searching. However, these efforts are focused on search time and the methods proposed are still too slow to be applied to computations in continuous data streams for which the time taken for extracting features is an essential parameter.

One known alternative consists of using an overall signature for an image to be analyzed. The indexing then often consists of a concatenation operation, resulting in a raw signature file. The comparison operation subsequently consists of determining a simple distance (or a similarity) between vectors. The advantage of this approach is that the computation of the signature is fast. The drawback is that it is generally less robust to transformations than the approaches using local descriptors. Furthermore, the comparison speed is proportional to the size of the reference base and to the size of the signatures. It is therefore about finding the smallest signatures possible.

The following references provide articles relating to the computation of overall signatures.

The publication by B. Thomee, M. J. Huiskes, E. M. Bakker, and M. J. Lew “An evaluation of content-based duplicate image detection methods for web search”, ICME 2013, compares multiple such approaches with respect to a common benchmark.

The image search engine “TinEye” (www.tineye.com), which probably uses a somewhat simpler approach referred to as “average hash”, is also worth mentioning. It relies on the fact that a small change in the content of the signal changes the hash key by only a small amount, unlike conventional hash functions. This allows similarity functions such as the Hamming distance, which is well known for finding “almost identical” content, to be used.

The publication by Zauner, Christoph “Implementation and Benchmarking of Perceptual Image Hash Functions” Master's thesis, Upper Austria University of Applied Sciences, Hagenberg Campus, 2010 reviews “perceptual hashing” functions, which may be likened to overall signatures.

The publication available online in April 2014 at the address http://blog.iconfinder.com/detecting-duplicate-images-using-python/ describes a perceptual hashing method based on block means, which falls under the same category of methods as those described in the article by Zauner. In particular, the method consists of the following steps:

converting a request image to grayscale;

reducing the gray image to a fixed size of “8×9” (8 rows, 9 columns);

comparing the intensity of adjacent pixels in each row in order to attribute a “true” value if a pixel has, for example, a grayscale value that is greater than that of the right adjacent pixel; and

encoding the resulting binary image (8×8) in hexadecimal.

FIG. 2a illustrates the construction of the hash function for a row ‘i’ according to this principle. In this example, a request image is reduced to a fixed size of 8 rows×9 columns. The step of comparing the pixels consists of attributing a ‘true’ value if the intensity of a pixel is greater than the intensity of the adjacent pixel. For this example, the row comprises pixel blocks (B1-B9) of respective intensity (B1=120, B2=121, B3=121, B4=88, B5=86, B6=136, B7=130, B8=84, B9=85). After comparing the right adjacent pixels, the resulting binary row encoded in hexadecimal (hash of row ‘i’) is a row with eight values ‘0, 0, 1, 1, 0, 1, 1, 0’. The resulting image is an image of size (8×8).

Although this method is very fast, it is only robust to certain transformations, and does not provide the expected robustness for numerous others, such as for left-right inversion and for small rotations.

Alternatively, a person skilled in the art could construct a symmetrical version of this method by comparing symmetrical pixels, as illustrated in FIG. 2b. A row ‘i’ is composed of eight columns B1 to B8 of respective pixel values ‘121, 122, 120, 87, 86, 125, 119, 84’. The comparison of the pixel values is carried out following straight central symmetry, the value of the pixel B1=121 with the value of the pixel B8=84 and so on. The resulting binary row encoded in hexadecimal (hash of row ‘i’) is a row with four values ‘1, 1, 0, 1’. The resulting image is an image of size (8×4). Such an approach reduces the number of comparison operations by two, thereby allowing a more compact signature to be obtained, but this makes the process less robust to transformations, in particular due to loss of information owing to there in fact being fewer regions in the images that are compared.

Thus, there is no solution in the prior art allowing an overall signature representing an image to be constructed that:

offers low algorithmic complexity in order to very quickly compute, with few machine resources, a signature for an image;

is compact enough to allow fast searching through a reference base; and

is robust to the transformations most commonly encountered on the Internet.

The present invention addresses this need.

### SUMMARY OF THE INVENTION

The described solution aims to solve the problem of searching for visual content in a visual data stream context.

In order to achieve this objective, one subject of the present invention is to propose a device and a method for detecting copies based on a new mode of obtaining the overall signature of an image.

Advantageously, the method of the invention that allows an image signature to be generated is fast, and allows a signature to be computed in a time of the order of or less than 5 ms for a machine with typical resources, such as e.g. a machine operating in a frequency range of around 3 GHz.

Again advantageously, the signature obtained via the method of the invention is very compact, smaller than 100 bytes, thus allowing quick and exhaustive searching through a large database, the content of the database being dependent on the available memory size and being able to contain, for example, of the order of 10⁷ to 10⁸ images.

Advantageously, the image signature obtained via the method of the invention may be quantified by means of a K-median method in order to be indexed in an inverted index structure allowing the search to be sped up. A similar method, quantifying a GIST signature by means of K-mean, is described in M. Douze, H. Jégou, H. Sandhawalia, L. Amsaleg, and C. Schmid, “Evaluation of gist descriptors for web-scale image search”, in International Conference on Image and Video Retrieval. New York, N.Y., USA: ACM, 2009, pp. 19:1-19:8. The K-median method is identical to the K-mean method (well known to those skilled in the art) while replacing the mean computation with a median computation.

More generally, the image signature obtained via the method of the invention is robust to the image transformations commonly encountered on the Internet.

The present invention will be advantageous in any application subject to the problems of having to search for illegal copies of protected content, wanting to measure the popularity of broadcast content, wanting to locate programming within a video or else for applications relating to the monitoring of social media.

In order to obtain the sought-after results, a method and a device for detecting copies or near-copies of images are proposed. The method consists of receiving an initial image, converting the initial image to grayscale, resizing the grayed image to a reduced image having a plurality of rows and an even number of columns, computing an overall signature for the reduced image, and determining whether the initial image is a copy or near-copy of an image according to the result of a comparison between the overall signature of the reduced image and reference image signatures. The step of computing the overall signature for the image comprises the steps of computing a row signature for each row of the reduced image, the computation being based on a comparison of values obtained statistically across subsets of symmetrical pixels in each row, and concatenating the row signatures in order to obtain an overall signature for the image.

In one embodiment, the step of computing a row signature comprises the steps of defining a plurality of regions of symmetrical pixels for the reduced image, and, in each row, selecting groups of subsets of symmetrical pixels (Pxi, Pyj), each subset being defined in such a way that if a pixel belongs to a group Pxi then its symmetrical partner in the row belongs to the group Pyj.

Advantageously, the statistical values are a mean across the subsets of pixels and the row signature is a value attributed to an element of a hash function according to the statistical value.

In one variant implementation, the value attributed to an element of a hash function is equal to ‘1’ if the mean obtained for a subset Pxi is greater than that obtained for the symmetrical subset Pyj.

Advantageously, the overall signature is an overall hash function obtained by concatenating the hash functions computed for each row. In one variant, the step of computing the overall signature comprises the addition of an overall statistic.

According to one embodiment, the resizing of the grayed image consists of reducing the initial image to a first image of ‘H’ rows by ‘W+K’ columns, where ‘W’ is even and ‘K’ is odd, then simplifying to a second image of ‘H’ rows by ‘W’ columns, where ‘W’ is even.

According to another embodiment, the step of computing the overall signature consists of computing an overall signature for the initial image and for converting the image to polar coordinates.

Advantageously, the method may additionally comprise, after the step of resizing the image, a step of determining a stable center of the image according to the content.

In one variant, the method may comprise a step of quantifying the signature by means of K-medians. The comparison step is then implemented by means of an inverted index structure.

The invention also covers a device for generating reference image signatures that allows an initial reference image to be received, the initial reference image to be converted to grayscale, the grayed reference image to be resized to a reduced reference image having a plurality of rows and an even number of columns, and a row signature to be computed for each row of the reduced reference image wherein the computation is based on a comparison of values obtained statistically across subsets of symmetrical pixels in each row. The obtained row signatures are concatenated in order to obtain a reference image signature.

The invention may operate in the form of a computer program product that comprises code instructions allowing the steps of the claimed methods to be carried out when the program is executed on a computer.

### DESCRIPTION OF THE FIGURES

Various aspects and advantages of the invention will appear in support of the description of one preferred, but non-limiting, mode of implementation of the invention, with reference to the figures below:

FIG. 1 illustrates the functional blocks of a known copy detection device;

FIGS. 2a and 2b illustrate two examples of the construction of a row signature according to known methods;

FIG. 3 illustrates the steps of the method for obtaining a signature for an image according to one embodiment of the invention;

FIG. 4 illustrates the functional blocks of the device of the invention in one embodiment.

### DETAILED DESCRIPTION OF THE INVENTION

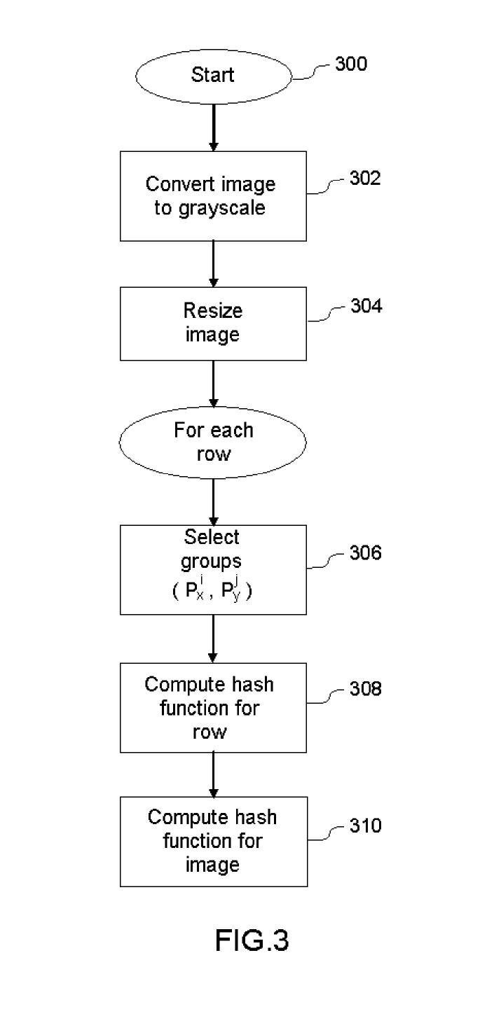

Reference is made to FIG. 3 which shows the main steps of the method of the invention for computing an overall signature for an image, i.e. the construction of an overall descriptor for the image. The method of the invention may be implemented using software and hardware elements. The software elements may be present in the form of a computer program product on a medium that can be read by the computer, which medium may be electronic, magnetic, optical or electromagnetic. The hardware elements may be wholly or partly present in the form of application-specific integrated circuits (ASICs) or field-programmable gate arrays (FPGAs), or in the form of a digital signal processor (DSP) or a graphics processing unit (GPU).

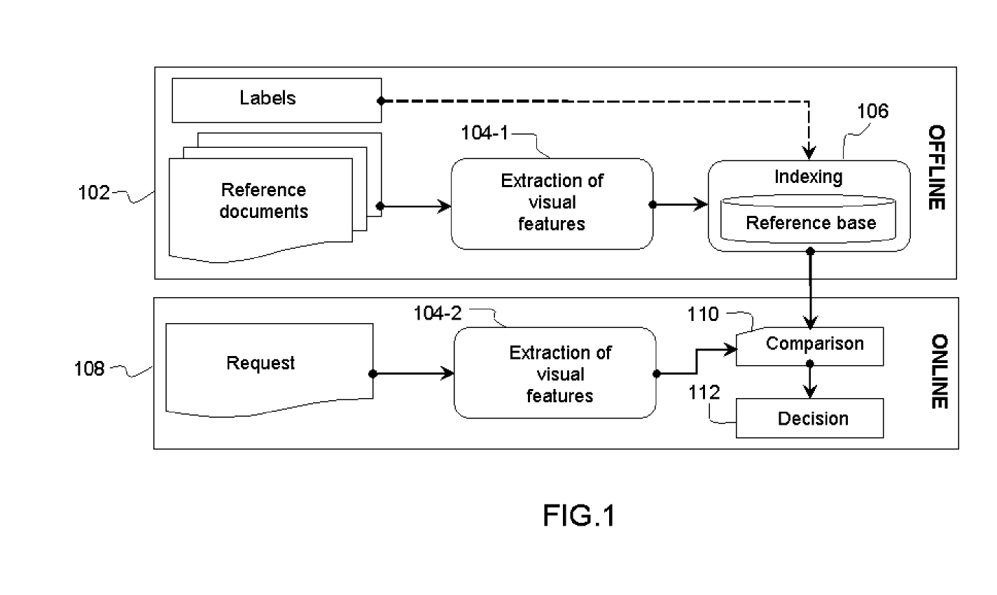

The method (300) is implemented within a device for extracting visual features, such as that shown in FIG. 1 (104-1, 104-2). The method is applied in disconnected offline mode while a reference image base is being set up, and operated in continuous online mode for analyzing images in streams of visual data.

The method starts (300) either on reception of a request to create a reference image, or on reception of a request to detect that an image in a stream of visual data is a copy or near-copy of a reference image.

Throughout the rest of the description of steps 302 to 310, the term “image” denotes an image arising from an initial image in a stream of visual data, or an image arising from an initial image intended to be a reference image.

In a first step (302), the initial image is converted to grayscale. This operation, which those skilled in the art are able to apply via conventional techniques, is not detailed here. One variant consists, for example, of computing the actual luminance. Another alternative may be to compute the function “(R+G+B)/3”, as proposed, in particular, in the OpenCV® library via the function cvCvtColor( ).

Advantageously, this step, which takes a mean of the chrominance planes, introduces a robustness to colorimetric transformations.

In a second step (304), the method allows the size of the “gray” image to be reduced. The image is first reduced to a first image whose size is ‘H’ rows by ‘W+K’ columns, where W is even (W=2w) and K is odd (K=2k+1) or zero (K=0). In one particular embodiment, only an even subset of columns is retained for resizing, e.g. by not retaining the center column of the image and, if necessary, not retaining the columns at the edges of the image, in order to keep a second image having ‘H’ rows of pixels by ‘W’ columns of pixels, where ‘W’ is even, and thus ultimately obtain a descriptor adapt to be invariant to right-left invariance.

The image may be resized by applying a known interpolation technique, a possible approach being to take the mean of the neighboring pixels. Alternatively, the image may be resized via linear, bilinear, bicubic or spline interpolation, for example.

Advantageously, this step allows details that are considered to be of little benefit in characterizing the reference image, such as watermarks or else text, to be removed. The resizing step also improves the robustness of the method to resampling transformations, whether or not the original ratio is retained.

In a following step (306), the method operates on each row of the reduced image in order to define a plurality of regions of symmetrical pixels. The method allows, for each row, groups of subsets of symmetrical pixels (Pₓⁱ,P_{y}ⁱ) to be selected, each subset being defined in such a way that if a pixel belongs to a group Pₓⁱ then its symmetrical partner in the row belongs to the group P_{y}ⁱ.

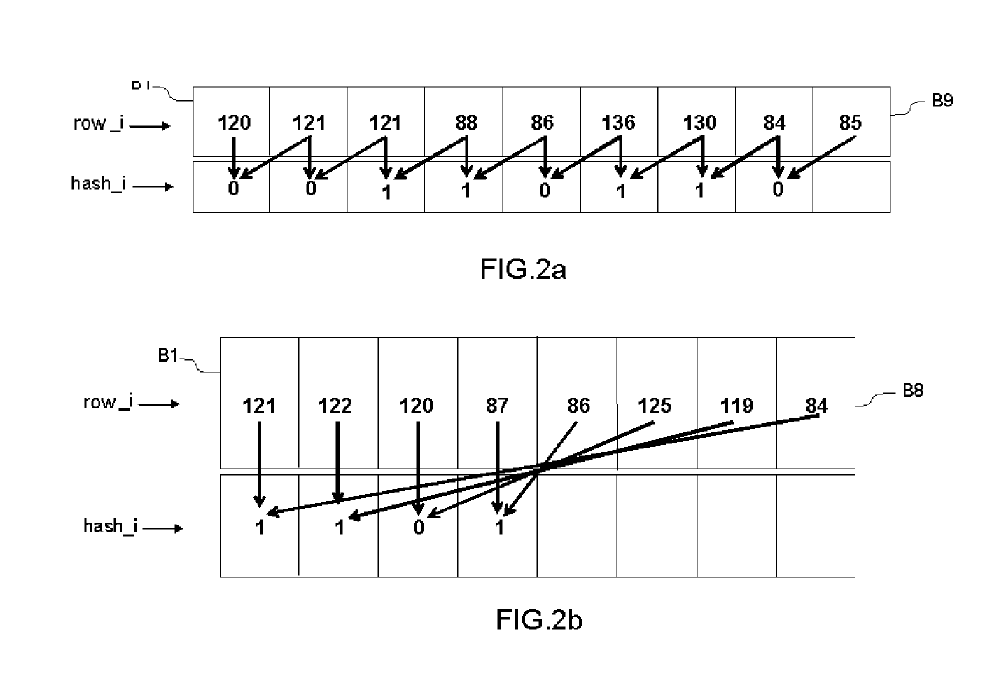

Again using the example of the row in FIG. 2b, table 1 below illustrates the selection of ‘J=12’ subsets of symmetrical pixels (Pₓⁱ,P_{y}ⁱ) for a row:

TABLE 1

| Groups Pₓⁱ | Groups P_{y}^{j} |
|---|---|
| 121 | 84 |
| 122 | 119 |
| 120 | 125 |
| 87 | 86 |
| 121, 122 | 119, 84 |
| 120, 87 | 86, 125 |
| 121, 120 | 125, 84 |
| 121, 87 | 86,84 |
| 121, 120, 87 | 86, 125, 84 |
| 121, 86, 119 | 122, 87, 84 |
| 121, 122, 86, 125 | 120, 87, 119, 84 |
| 121, 87, 86 | 87, 86, 84 |

It should be noted in this example that the four first subsets (121, 122, 120, 87) of group Pₓⁱ are singletons, identical to the basic perceptual hash function described above for the symmetrical version.

Advantageously, the subsets that are defined are not necessarily “totally exclusive”. Thus, in the last row of table 1, the pixels (87, 86) corresponding to the blocks in the middle of row ‘i’ belong both to the subset (121, 87, 86) of the group of pixels Pₓⁱ and to the subset (87, 86, 84) of the group of pixels P_{y}ⁱ.

In a following step (308), the method allows a statistic to be calculated for each subset of pixels and a value to be attributed to the element of the corresponding hash function according to the obtained statistical value.

In one particular embodiment and as illustrated in table 2 below, which reuses the example of table 1, the statistic consists of computing, for each subset of pixels, a mean ‘μᵢ’ for the pixels of group Pₓⁱ and ‘μⱼ’ for the pixels of group P_{y}ⁱ, then of attributing the value ‘1’ to the hash element if the mean obtained for the subassembly Pₓⁱ is larger than that for the subset P_{y}ⁱ, or otherwise the value ‘0’.

TABLE 2

| | | Hash value |
|---|---|---|
| μᵢ = Mean Pₓⁱ | μⱼ = Mean P_{y}^{j} | (μᵢ > μⱼ ?) |
| 121 | 84 | 1 |
| 122 | 119 | 1 |
| 120 | 125 | 0 |
| 87 | 86 | 1 |
| 121.5 | 101.5 | 1 |
| 103.5 | 105.5 | 0 |
| 120.5 | 104.5 | 1 |
| 104 | 85 | 1 |
| 109.33 | 98.33 | 1 |
| 108.67 | 97.67 | 1 |
| 113.5 | 102.5 | 1 |
| 98 | 85.67 | 1 |

After having computed, for each row of the image, the hash value for each subset of pixels, the method allows, in a following step (310), an overall hash value to be computed for the reduced image. The overall hash function is the concatenation of the hash functions computed for each row. In the preceding example, the size of the overall hash function is ‘H×J’. As the hash values are binary (they only take the values 0 or 1), the ‘H×J’ dimensions of the overall hash function may be encoded in at most E[H×J/8]+1 bytes, where E[x] is the integer part of x.

Advantageously, by defining additional symmetrical groups, the signature becomes more robust to other transformations, such as embedded text or images, as the compared values are averaged (smoothed) in multiple places on the image.

In one alternative embodiment, it is possible for the computation of the signature of the image to add (to the overall hash function) the number of times that the mean of two elements of a pair (Pₓⁱ, P_{y}ⁱ) is identical (number of equivalents).

In one alternative embodiment, it is possible for the computation of the overall signature of the image to add (to the overall hash function) one or more overall statistics.

For example, the computation may take into account the number of times that the mean of two elements of a pair is identical (number of equivalents) as well as an overall statistic, such as the mean intensity of the image.

In this variant, the size of the overall signature is then “H×J+G+1”, where ‘G’, the number of overall statistics added, i.e. the mean intensity of the image, is equal to 1.

If ‘G’ overall statistics are added—with, for example, ‘G=3’ as the mean, the variance and the median of the image—plus the number of equivalents, then the size of the overall hash function is equal to “H×J+G+1=HJ+4”.

If the number of equivalents is encoded, for example, in two bytes and each overall statistic is encoded in two bytes, then the signature of size “H×J+G+1” may be encoded in (E[H×J/8]+1+2×G+2) bytes.

In a different embodiment, the method 300 may be applied to the original image in grayscale and to its conversion to polar coordinates. In this implementation, a person skilled in the art will note that the center of symmetry on a line may be arbitrarily fixed for all images.

In one variant embodiment, the center of symmetry may be automatically determined according to the content of the image so as to obtain a more stable center. One way of doing this may be, for example, to compute the barycenter of the pixels (mean of the spatial positions weighted by the grayscale value of the pixels) for a succession of operations of resizing to a size smaller than the original image, then to choose the center of symmetry when the barycenter stays localized in a stable spatial neighborhood.

Alternatively, the barycenter of the pixels may potentially be computed after digital filtering that may, for example, convert the image to grayscale.

The method 300 for generating a signature for an image may be followed by a comparison method when it is applied in continuous online mode. As described above, the comparison carried out within a comparison module of the processing chain (module 110 of FIG. 1) allows the overall signature obtained online to be compared with signatures from the reference base which have been computed offline.

In one variant, the method may comprise a step of quantifying the signature by means of K-medians. The comparison step is then implemented by means of an inverted index structure. Such a method for speeding up the search time via K-mean quantification is described for the GIST descriptor in M. Douze, H. Jegou, H. Sandhawalia, L. Amsaleg, and C. Schmid, “Evaluation of gist descriptors for web-scale image search”, in International Conference on Image and Video Retrieval. New York, N.Y., USA: ACM, 2009, pp. 19:1-19:8. Preferably, quantification is carried out by means of a K-median algorithm, which is identical to the K-means algorithm while replacing the mean with a median.

In one embodiment, the comparison is carried out by computing a distance between the overall signature and image signatures arising from the reference base. In one variant, the distance is composite and corresponds to the mean of the distances ‘dH’ and ‘dME’, where dH is the Hamming distance across the overall hash functions and ‘dME’ is a distance across the overall statistics and the number of equivalents. For example, dME may be the Manhattan distance or the Euclidean distance.

A preferred implementation of the preceding embodiment is that in which the size of reduced image is equal to ‘H=W=16’, the number of groups of subsets of pixels is equal to ‘J=16’, the distance across the global hash functions ‘dH’ is taken to be the Hamming distance and the distance across the grayscale means ‘dME’ is the Manhattan distance L1. In this configuration, the 16 groups for one row are then set up according to the following table 3, where {pₖ, k=1, . . . 16} are the successive pixels of one row of the reduced image, in order from left to right, p₁ being the leftmost pixel and p₁₆ the rightmost pixel:

TABLE 3

| Groups Pₓⁱ | Groups Pₓ^{j} |
|---|---|
| p₁ | p₁₆ |
| p₂ | p₁₅ |
| p₃ | p₁₄ |
| p₄ | p₁₃ |
| p₅ | p₁₂ |
| p₆ | p₁₁ |
| p₇ | p₁₀ |
| p₈ | p₉ |
| p₁, p₂ | p₁₆, p₁₅ |
| p₃, p₄ | p₁₄, p₁₃ |
| p₅, p₆ | p₁₂, p₁₁ |
| p₇, p₈ | p₁₀, p₉ |
| p₁, p₂, p₃, p₄ | p₁₆, p₁₅, p₁₄, p₁₃ |
| p₅, p₆, p₇, p₈ | p₁₂, p₁₁, p₁₀, p₉ |
| {pᵢ}:i ∈ [1,8] | {pⱼ}:j ∈ [9,16] |
| {p₂ᵢ}:i ∈ [1,8] | {p₂ⱼ₋₁}:j ∈ [1,8] |

The method of the invention has been evaluated with respect to the benchmark proposed by B. Thomee, M. J. Huiskes, E. M. Bakker, and M. J. Lew “An evaluation of content-based duplicate image detection methods for web search”, ICME 2013. It consists of 6000 images that have been transformed in 60 different ways, the transformations having been chosen after a survey of 45 people who are familiar with image processing and who reported the transformations that they most commonly encounter on the Internet. The 360 000 resulting images were merged with two million images in order to form the reference base. The 6000 original images are used in queries and the performance is measured in terms of “mean average precision” (MAP), a measurement well known to those skilled in the art.

The method has been compared to the ‘GIST’ method, which obtains the best results with respect to the benchmark, and to ‘TOP-SURF’, which is a method whose performance relies on the use of local descriptors.

A reference for the ‘GIST’ method is: A. Oliva and A. Torralba, “Modeling the shape of the scene: A holistic representation of the spatial envelope”, International Journal of Computer Vision, vol. 42, no. 3, pp. 145-175, 2001.

A reference for the ‘TOP-SURF’ method is: B. Thomee, E. M. Bakker and M. S. Lew, “TOP-SURF: a visual words toolkit” in ACM Multimedia, A C M, 2010, pp. 1473-1476.

The experimental results have been reported both for precision (MAP) and computing time (in seconds). The computing time is split between the time taken for computing the signature (‘description’ in table 4 below) and the time taken for searching through the reference base (‘comparison’ in table 4 below).

Additionally, the method has been combined with a method for speeding up the search time via K-median quantification, as described above.

TABLE 4

Computing time (seconds)

| Method | description | comparison | MAP |
|---|---|---|---|
| TOP SURF | 0.340 | 2.2 | 93.7% |
| GIST | 0.05 | 9 | 93.2% |
| The method of | 0.005 | 0.120 | 99.1% |
| the invention | | | |
| The method of | 0.005 | 0.0015 | 96.7% |
| the invention | | | |
| quantified | | | |

In its two versions, the performance of the proposed method is superior to the methods of the prior art, and above all is much faster in the comparison step.

Thus the advantages of the method of the invention are, inter alia, that a signature is computed very quickly, less than 5 ms on average with a single Intel® Core™ i7-4800MQ CPU @ 2.70 GHz processor core for an image of VGA size. Additionally, the signature is compact enough to allow a search through many millions of images in less than 100 ms, still with a single Intel® Core™ i7-4800MQ CPU @2.70 GHz processor core. Lastly, the method allows the signature to be robust to the transformations most commonly encountered on the Internet.

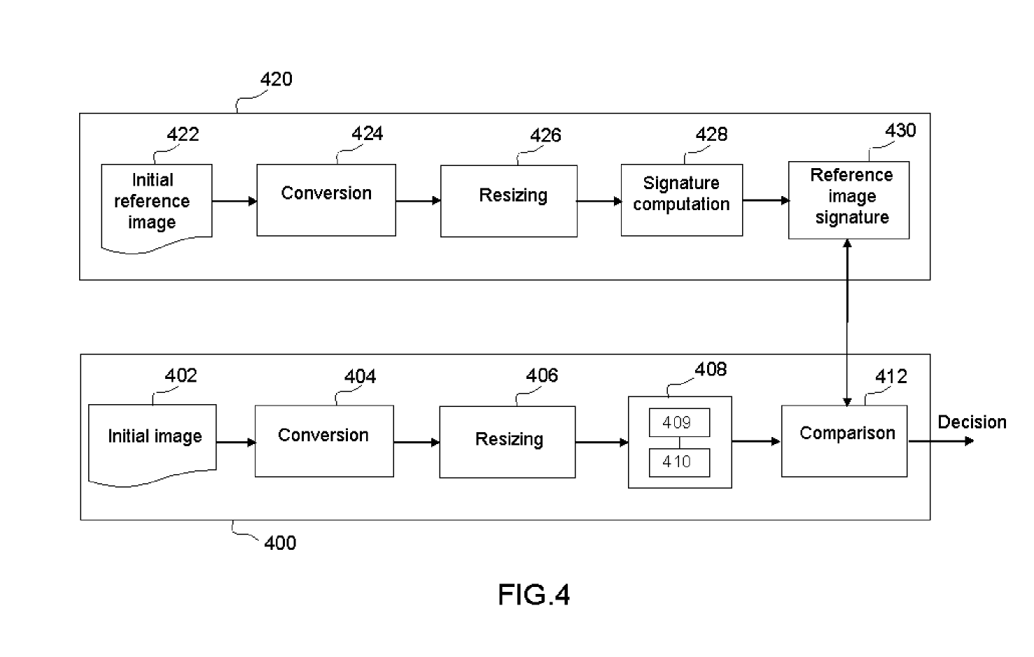

FIG. 4 illustrates the functional blocks of the device (400) of the invention for detecting copies or near-copies of images in one embodiment. The device comprises modules that are adapted to execute the steps of the method that is described in reference to FIG. 3.

The device (400) comprises a receiver module (402) adapt to receive an initial image. The initial image is transmitted to a conversion module (404) adapt to convert the initial image to grayscale. Once grayed, the grayed image is transmitted to a resizing module (406) adapt to resize the grayed image to a reduced image, the reduced image having a plurality of rows and an even number of columns. The reduced image is subsequently transmitted to a computing module (408) adapt to compute an overall signature for the reduced image. Advantageously, the computing module comprises a first component (409) allowing a row signature to be computed for each row of the reduced image, and a second component (410) allowing the row signatures to be concatenated in order to obtain an overall signature. In general, the computation is based on a comparison of values obtained statistically across subsets of symmetrical pixels in each row. The device additionally comprises a comparison module (412) adapt to compare the overall signature of the obtained reduced image to reference image signatures (430) in order to determine whether the initial image is a copy or near-copy of an image according to the result of the comparison.

The reference image signatures (430) are obtained by a device (420) operating offline and comprising a receiver module (422) adapt to receive an initial reference image, a conversion module (424) adapt to convert the initial reference image to grayscale, a resizing module (426) adapt to resize the grayed reference image to a reduced reference image having a plurality of rows and an even number of columns, a computing module (428) adapt to compute a row signature for each row of the reduced reference image and wherein the computation is based on a comparison of values obtained statistically across subsets of symmetrical pixels in each row, and a module (430) for concatenating the row signatures and obtaining a reference image signature.

The modules of the device of the invention may be hardware and/or software elements. The software elements may be present in the form of a computer program product on a medium that can be read by the computer, which medium may be electronic, magnetic, optical or electromagnetic. The hardware elements may be wholly or partly present in the form of application-specific integrated circuits (ASICs) or field-programmable gate arrays (FPGAs), or in the form of a digital signal processor (DSP) or a graphics processing unit (GPU).

1. A method for detecting copies or near-copies of images, comprising the steps of:
receiving an initial image;
converting the initial image to grayscale;
resizing the grayed image to a reduced image having a plurality of rows and an even number of columns;
computing an overall signature for the reduced image; and
determining whether the initial image is a copy or near-copy of an image according to the result of a comparison between the overall signature of the reduced image and reference image signatures;
the method wherein the step of computing an overall signature comprises the steps of:
computing a row signature for each row of the reduced image, said computation being based on a comparison of values obtained statistically across subsets of symmetrical pixels in each row; and
concatenating the row signatures in order to obtain an overall signature.

2. The method as claimed in claim 1, wherein the step of computing a row signature comprises the steps of:
defining a plurality of regions of symmetrical pixels for the reduced image; and
in each row, selecting groups of subsets of symmetrical pixels (Pₓⁱ,P_{y}ⁱ), each subset being defined in such a way that if a pixel belongs to a group Pₓⁱ then its symmetrical partner in the row belongs to the group P_{y}ⁱ.

3. The method as claimed in claim 1, wherein the statistical values are a mean across the subsets of pixels and the row signature is a value attributed to an element of a hash function according to the statistical value.

4. The method as claimed in claim 3, wherein the value attributed to an element of a hash function is equal to ‘1’ if the mean obtained for a subset Pₓⁱ is greater than that obtained for the symmetrical subset P_{y}ⁱ.

5. The method as claimed in claim 3, wherein the overall signature is an overall hash function obtained by concatenating the hash functions computed for each row.

6. The method as claimed in claim 1, wherein the step of resizing the grayed image consists of reducing the initial image to a first image of ‘H’ rows by ‘W+K’ columns, where ‘W’ is even and ‘K’ is odd, then simplifying to a second image of ‘H’ rows by ‘W’ columns, where ‘W’ is even.

7. The method as claimed in claim 1, wherein the step of computing the overall signature comprises the addition of one or more overall statistics for the image.

8. The method as claimed in claim 1, wherein the step of computing the overall signature consists of computing an overall signature for the initial image and for converting the image to polar coordinates.

9. The method as claimed in claim 1, additionally comprising, after the step of resizing the image, a step of determining a stable center of the image according to the content.

10. The method as claimed in claim 1, additionally comprising a step of quantifying the signature by means of K-medians and wherein the comparison step is implemented by means of an inverted index structure.

11. A computer program product, said computer program comprising code instructions to operate the steps of the method as claimed in claim 1, when said program is executed on a computer.

12. A device for detecting copies or near-copies of images, comprising:
a receiver module adapted to receive an initial image;
a conversion module adapted to convert the initial image to grayscale;
a resizing module adapted to resize the grayed image to a reduced image having a plurality of rows and an even number of columns;
a computing module adapted to compute an overall signature for the reduced image; and
a comparison module adapted to compare the overall signature of the reduced image to reference image signatures in order to determine whether the initial image is a copy or near-copy of an image according to the result of the comparison;
the device wherein the computing module comprises:
a component for computing a row signature for each row of the reduced image, the computation being based on a comparison of values obtained statistically across subsets of symmetrical pixels of each row; and
a component for concatenating the row signatures in order to obtain an overall signature.

13. The device as claimed in claim 12, wherein the component for computing a row signature allows:
a plurality of regions of symmetrical pixels for the reduced image to be defined; and
for each row, groups of subsets of symmetrical pixels (Pₓⁱ,P_{y}ⁱ) to be selected, each subset being defined in such a way that if a pixel belongs to a group Pₓⁱ then its symmetrical partner in the row belongs to the group P_{y}ⁱ.

14. The device as claimed in claim 12, wherein the statistical values are a mean across the subsets of pixels and the row signature is a value attributed to an element of a hash function according to the statistical value.

15. The device as claimed in claim 14, wherein the value attributed to an element of a hash function is equal to ‘1’ if the mean obtained for a subset Pₓⁱ is greater than that obtained for the symmetrical subset P_{y}ⁱ.

16. The device as claimed in claim 14, wherein the overall signature is an overall hash function obtained by concatenating the hash functions computed for each row.

17. The device as claimed in claim 12, wherein the module for resizing the grayed image allows the initial image to be reduced to a first image of ‘H’ rows by ‘W+K’ columns, where ‘W’ is even and ‘K’ is odd, then the first image to be simplified to a second image of ‘H’ rows by ‘W’ columns, where ‘W’ is even.

18. The device as claimed in claim 12, wherein the module for computing the overall signature allows the addition of one or more overall statistics for the image to be taken into account.

19. The device as claimed in claim 12, wherein the module for computing the overall signature allows an overall signature for the initial image and for converting the initial image to polar coordinates to be computed.

20. The device as claimed in claim 12, comprising a module for determining a stable center of the resized image according to the content.

21. The device as claimed in claim 12, additionally comprising a module adapt to quantify the signature by means of K-medians and wherein the comparison module is implemented by means of an inverted index structure.

22. A method for generating a reference image signature, comprising the steps of:
receiving an initial reference image;
converting the initial reference image to grayscale;
resizing the grayed reference image to a reduced reference image having a plurality of rows and an even number of columns;
computing a row signature for each row of the reduced reference image, said computation being based on a comparison of values obtained statistically across subsets of symmetrical pixels in each row; and
concatenating the row signatures in order to obtain a reference image signature.

23. The method as claimed in claim 22, additionally comprising steps of:
defining a plurality of regions of symmetrical pixels for the reduced image; and
in each row, selecting groups of subsets of symmetrical pixels, each subset being defined in such a way that if a pixel belongs to a group Pₓⁱ then its symmetrical partner in the row belongs to the group P_{y}ⁱ.

24. A device for generating a reference image signature, comprising:
a receiver module adapt to receive an initial reference image;
a conversion module adapt to convert the initial reference image to grayscale;
a resizing module adapt to resize the grayed reference image to a reduced reference image having a plurality of rows and an even number of columns;
a computing module adapt to compute a row signature for each row of the reduced reference image, said computation being based on a comparison of values obtained statistically across subsets of symmetrical pixels in each row; and
a module for concatenating the row signatures and obtaining a reference image signature.

25. The device as claimed in claim 12, wherein the reference image signatures are obtained by a device comprising:
a receiver module adapt to receive an initial reference image;
a conversion module adapt to convert the initial reference image to grayscale;
a resizing module adapt to resize the grayed reference image to a reduced reference image having a plurality of rows and an even number of columns;
a computing module adapt to compute a row signature for each row of the reduced reference image, said computation being based on a comparison of values obtained statistically across subsets of symmetrical pixels in each row; and
a module for concatenating the row signatures and obtaining a reference image signature.

26. A computer program product, said computer program comprising code instructions allowing the steps of the method as claimed in claim 22 to be carried out, when said program is executed on a computer.
